(19) United States
(12) Patent Application Publication
(10) Pub. No.: US 2017/0161278 A1
(43) Pub. Date: Jun. 8, 2017

(54) Degrees of Separation Network Builder

(71) Applicant: International Business Machines Corporation, Armonk, NY (US)

(72) Inventors: Kevin C. Carr, Research Triangle Park, NC (US); Al Chakra, Apex, NC (US); Jeremy Crafts, Raleigh, NC (US); Bryan M. Dempsey, Clinton Corners, NY (US); Marit L. Imsdahl, Morrisville, NC (US)

(21) Appl. No.: 14/962,135

(22) Filed: Dec. 8, 2015

(51) Int. Cl. G06F 17/30

(52) U.S. Cl. CPC G06F 17/3053; G06F 17/30867; G06F 17/30554

(57) ABSTRACT

An approach is disclosed to provide a degrees of separation network builder. In the approach, an action is taken by a first mobile device user that communicates with a second mobile device of second user. The two devices are proximate to each other. Affinity data pertaining to the first user is accessible from the first mobile device, and affinity data of the second user is received at the first device. An affinity score is computed based on comparing the first user's affinity data with the second user's affinity data. The affinity score reflects an estimated affinity of the first user and second user. This affinity score is displayed on the first device for viewing to the first user.

### BACKGROUND

Various social media websites assist users in connecting with people you may know or people that are a part of one of your connections' larger networks. These connection tools help people expand their professional network, social network, gain new friends, or simply find people that share their similar interests. Today, in order to make these connections you must go through a social media website. These websites lack the in-person element to network building. While it is advantageous to make online connections, it is also advantageous, but quite different, to establish face-to-face connections and speak with someone who is part of one or more similar social or professional networks.

### BRIEF SUMMARY

An approach is disclosed to provide a degrees of separation network builder. In the approach, an action is taken by a first mobile device user that communicates with a second mobile device of second user. The two devices are proximate to each other. Affinity data pertaining to the first user is accessible from the first mobile device, and affinity data of the second user is received at the first device. An affinity score is computed based on comparing the first user's affinity data with the second user's affinity data. The affinity score reflects an estimated affinity of the first user and second user. This affinity score is displayed on the first device for viewing to the first user.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present disclosure, as defined solely by the claims, will become apparent in the non-limiting detailed description set forth below.

### BRIEF DESCRIPTION OF THE SEVERAL VIEWS OF THE DRAWINGS

The present disclosure may be better understood, and its numerous objects, features, and advantages made apparent to those skilled in the art by referencing the accompanying drawings, wherein:

FIG. 1 depicts a schematic diagram of one illustrative embodiment of a question answering (QA) system in a computer network;

FIG. 2 illustrates an information handling system, more particularly, a processor and common components, which is a simplified example of a computer system capable of performing the computing operations described herein;

FIG. 3 is an exemplary diagram depicting the components utilized in the degrees of separation network builder;

FIG. 4 is an exemplary flowchart that performs a social affinity setup process;

FIG. 5 is an exemplary flowchart that shows two users utilizing the social affinity process;

FIG. 6 is an exemplary flowchart that shows a process that shares affinity related data based on a current sharing level; and

FIG. 7 is an exemplary flowchart that shows a process compares shared affinity data and computes an affinity score.

### DETAILED DESCRIPTION

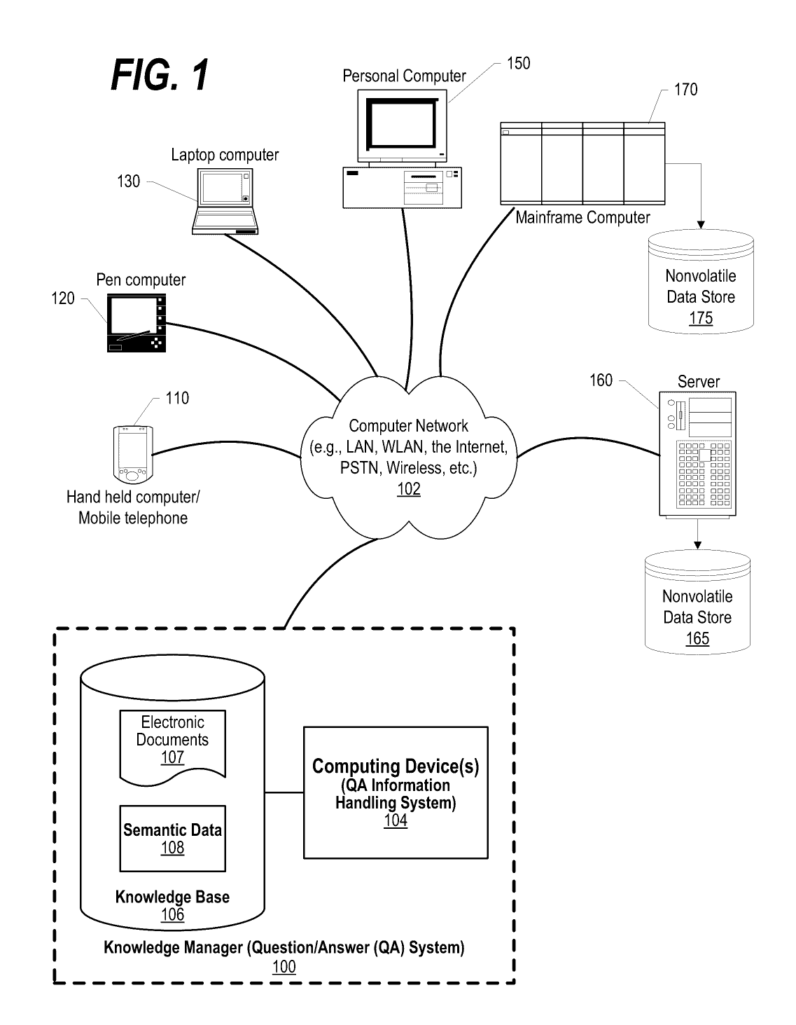

FIGS. 1-7 depict a Degrees of Separation Application that provides people with the ability to have an in-person networking experience. When two people meet and want to share contacts, they can simply “bump” their phones using this approach. This action begins the matching process. A search will take place on both phones for matching contacts (via email, phone numbers, social media contacts, etc.). In one embodiment, a question-answering (QA) system is utilized to find matches. The users receive compatibility scores that indicate how well they connect based upon their common contacts and interests (e.g., music, blogs, activities, contacts, etc.). Both users will be able to look into the details of their compatibility. Far flung connections will be made, interests will be shared quickly and lead to further discussion, and the in-person element will be enhanced. This approach can change the way people find job opportunities, make new friends, suggest friends, suggest activities or music, and most importantly, it will increase people's inter-connectivity with the larger population.

For the user, potential advantages include: (1) new business connections, (2) new friends, (3) the opportunity to help someone outside of their network, and (4) compatibility metric between former strangers. The following provides two use case examples of potential benefits derived by implementing and using the approach provided herein:

Use Case 1. In this use case Jessica and John are at a grocery and bump into each other. They recognize each other, but can not remember where they have met before. They decide to “bump” their smart phones to use the Degrees of Separation Application, and they find a 36% compatibility score. They look at their mutual interests/past events/hobbies and realize that they both attended the Debate club a few months back. With this information they remember where they had met and they start talking about their experience at the Debate club meeting.

Use Case 2. Max and Christian are sitting next to each other in a cafe (they haven't met before). After exchanging a few polite sentences they decide to “bump” their phones to use the Degrees of Separation Application in ordeder to see what they have in common. After bumping their phones they get a 73% compatibility score. Next they look at the contacts they have in common and realize that 37 of their 200 contacts are the same. They also notice that they both went to the same high school, but Max was a year ahead of Christian. In addition the two club soccer teams that they each had joined during the previous summer played each other during the final Championship game. Through the use of the Degrees of Separation Application, Max and Christian have found a common topic they can talk about that they are both passionate about.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions. The following detailed description will generally follow the summary of the disclosure, as set forth above, further explaining and expanding the definitions of the various aspects and embodiments of the disclosure as necessary.

FIG. 1 depicts a schematic diagram of one illustrative embodiment of a question/answer (QA) system 100 in a computer network 102. QA system 100 may include knowledge manager 104, which comprises one or more processors and one or more memories, and potentially any other computing device elements generally known in the art including buses, storage devices, communication interfaces, and the like. Computer network 102 may include other computing devices in communication with each other and with other devices or components via one or more wired and/or wireless data communication links, where each communication link may comprise one or more of wires, routers, switches, transmitters, receivers, or the like. QA system 100 and network 102 may enable question/answer (QA) generation functionality for one or more content users. Other embodiments may include QA system 100 interacting with components, systems, sub-systems, and/or devices other than those depicted herein.

QA system 100 may receive inputs from various sources. For example, QA system 100 may receive input from the network 102, a corpus of electronic documents 107 or other data, semantic data 108, and other possible sources of input. In one embodiment, some or all of the inputs to QA system 100 route through the network 102 and stored in knowledge base 106. The various computing devices on the network 102 may include access points for content creators and content users. Some of the computing devices may include devices for a database storing the corpus of data. The network 102 may include local network connections and remote connections in various embodiments, such that QA system 100 may operate in environments of any size, including local and global, e.g., the Internet. Additionally, QA system 100 serves as a front-end system that can make available a variety of knowledge extracted from or represented in documents, network-accessible sources and/or structured data sources. In this manner, some processes populate the knowledge manager with the knowledge manager also including input interfaces to receive knowledge requests and respond accordingly.

In one embodiment, a content creator creates content in a document 107 for use as part of a corpus of data with QA system 100. The document 107 may include any file, text, article, or source of data for use in QA system 100. Content users may access QA system 100 via a network connection or an Internet connection to the network 102, and may input questions to QA system 100, which QA system 100 answers according to the content in the corpus of data. As further described below, when a process evaluates a given section of a document for semantic content, the process can use a variety of conventions to query it from knowledge manager 104. One convention is to send a well-formed question.

Semantic data 108 is content based on the relation between signifiers, such as words, phrases, signs, and symbols, and what they stand for, their denotation, or connotation. In other words, semantic data 108 is content that interprets an expression, such as by using Natural Language Processing (NLP). In one embodiment, the process sends well-formed questions (e.g., natural language questions, etc.) to QA system 100 and QA system 100 may interpret the question and provide a response that includes one or more answers to the question. In some embodiments, QA system 100 may provide a response to users in a ranked list of answers.

In some illustrative embodiments, QA system 100 may be the IBM Watson™ QA system available from International Business Machines Corporation of Armonk, N.Y., which is augmented with the mechanisms of the illustrative embodiments described hereafter. The IBM Watson™ knowledge manager system may receive an input question which it then parses to extract the major features of the question, that in turn are then used to formulate queries that are applied to the corpus of data. Based on the application of the queries to the corpus of data, a set of hypotheses, or candidate answers to the input question, are generated by looking across the corpus of data for portions of the corpus of data that have some potential for containing a valuable response to the input question.

The IBM Watson™ QA system then performs deep analysis on the language of the input question and the language used in each of the portions of the corpus of data found during the application of the queries using a variety of reasoning algorithms. There may be hundreds or even thousands of reasoning algorithms applied, each of which performs different analysis, e.g., comparisons, and generates a score. For example, some reasoning algorithms may look at the matching of terms and synonyms within the language of the input question and the found portions of the corpus of data. Other reasoning algorithms may look at temporal or spatial features in the language, while others may evaluate the source of the portion of the corpus of data and evaluate its veracity.

The scores obtained from the various reasoning algorithms indicate the extent to which the potential response is inferred by the input question based on the specific area of focus of that reasoning algorithm. Each resulting score is then weighted against a statistical model. The statistical model captures how well the reasoning algorithm performed at establishing the inference between two similar passages for a particular domain during the training period of the IBM Watson™ QA system. The statistical model may then be used to summarize a level of confidence that the IBM Watson™ QA system has regarding the evidence that the potential response, i.e. candidate answer, is inferred by the question. This process may be repeated for each of the candidate answers until the IBM Watson™ QA system identifies candidate answers that surface as being significantly stronger than others and thus, generates a final answer, or ranked set of answers, for the input question. More information about the IBM Watson™ QA system may be obtained, for example, from the IBM Corporation website, IBM Redbooks, and the like. For example, information about the IBM Watson™ QA system can be found in Yuan et al., “Watson and Healthcare,” IBM developerWorks, 2011 and “The Era of Cognitive Systems: An Inside Look at IBM Watson and How it Works” by Rob High, IBM Redbooks, 2012.

Types of information handling systems that can utilize QA system 100 range from small handheld devices, such as handheld computer/mobile telephone 110 to large mainframe systems, such as mainframe computer 170.

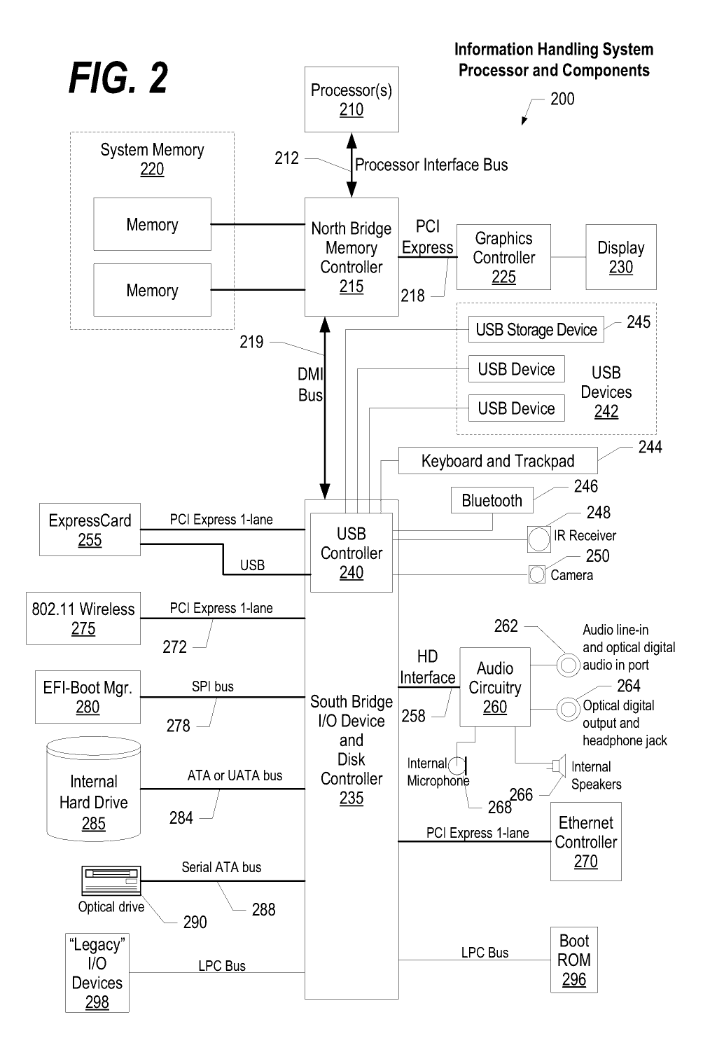

Examples of handheld computer 110 include personal digital assistants (PDAs), personal entertainment devices, such as MP3 players, portable televisions, and compact disc players. Other examples of information handling systems include pen, or tablet, computer 120, laptop, or notebook, computer 130, personal computer system 150, and server 160. As shown, the various information handling systems can be networked together using computer network 102. Types of computer network 102 that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems shown in FIG. 1 depicts separate nonvolatile data stores (server 160 utilizes nonvolatile data store 165, and mainframe computer 170 utilizes nonvolatile data store 175. The nonvolatile data store can be a component that is external to the various information handling systems or can be internal to one of the information handling systems. An illustrative example of an information handling system showing an exemplary processor and various components commonly accessed by the processor is shown in FIG. 2.

FIG. 2 illustrates information handling system 200, more particularly, a processor and common components, which is a simplified example of a computer system capable of performing the computing operations described herein. Information handling system 200 includes one or more processors 210 coupled to processor interface bus 212. Processor interface bus 212 connects processors 210 to Northbridge 215, which is also known as the Memory Controller Hub (MCH). Northbridge 215 connects to system memory 220 and provides a means for processor(s) 210 to access the system memory. Graphics controller 225 also connects to Northbridge 215. In one embodiment, PCI Express bus 218 connects Northbridge 215 to graphics controller 225. Graphics controller 225 connects to display device 230, such as a computer monitor.

Northbridge 215 and Southbridge 235 connect to each other using bus 219. In one embodiment, the bus is a Direct Media Interface (DMI) bus that transfers data at high speeds in each direction between Northbridge 215 and Southbridge 235. In another embodiment, a Peripheral Component Interconnect (PCI) bus connects the Northbridge and the Southbridge. Southbridge 235, also known as the I/O Controller Hub (ICH) is a chip that generally implements capabilities that operate at slower speeds than the capabilities provided by the Northbridge. Southbridge 235 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 296 and “legacy” I/O devices (using a “super I/O” chip). The “legacy” I/O devices (298) can include, for example, serial and parallel ports, keyboard, mouse, and/or a floppy disk controller. The LPC bus also connects Southbridge 235 to Trusted Platform Module (TPM) 295. Other components often included in Southbridge 235 include a Direct Memory Access (DMA) controller, a Programmable Interrupt Controller (PIC), and a storage device controller, which connects Southbridge 235 to nonvolatile storage device 285, such as a hard disk drive, using bus 284.

ExpressCard 255 is a slot that connects hot-pluggable devices to the information handling system. ExpressCard 255 supports both PCI Express and USB connectivity as it connects to Southbridge 235 using both the Universal Serial Bus (USB) the PCI Express bus. Southbridge 235 includes USB Controller 240 that provides USB connectivity to devices that connect to the USB. These devices include webcam (camera) 250, infrared (IR) receiver 248, keyboard and trackpad 244, and Bluetooth device 246, which provides for wireless personal area networks (PANs). USB Controller 240 also provides USB connectivity to other miscellaneous USB connected devices 242, such as a mouse, removable nonvolatile storage device 245, modems, network cards, ISDN connectors, fax, printers, USB hubs, and many other types of USB connected devices. While removable nonvolatile storage device 245 is shown as a USB-connected device, removable nonvolatile storage device 245 could be connected using a different interface, such as a Firewire interface, etcetera.

Wireless Local Area Network (LAN) device 275 connects to Southbridge 235 via the PCI or PCI Express bus 272. LAN device 275 typically implements one of the IEEE .802.11 standards of over-the-air modulation techniques that all use the same protocol to wireless communicate between information handling system 200 and another computer system or device. Optical storage device 290 connects to Southbridge 235 using Serial ATA (SATA) bus 288. Serial ATA adapters and devices communicate over a high-speed serial link. The Serial ATA bus also connects Southbridge 235 to other forms of storage devices, such as hard disk drives. Audio circuitry 260, such as a sound card, connects to Southbridge 235 via bus 258. Audio circuitry 260 also provides functionality such as audio line-in and optical digital audio in port 262, optical digital output and headphone jack 264, internal speakers 266, and internal microphone 268. Ethernet controller 270 connects to Southbridge 235 using a bus, such as the PCI or PCI Express bus. Ethernet controller 270 connects information handling system 200 to a computer network, such as a Local Area Network (LAN), the Internet, and other public and private computer networks.

While FIG. 2 shows one information handling system, an information handling system may take many forms, some of which are shown in FIG. 1. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory.

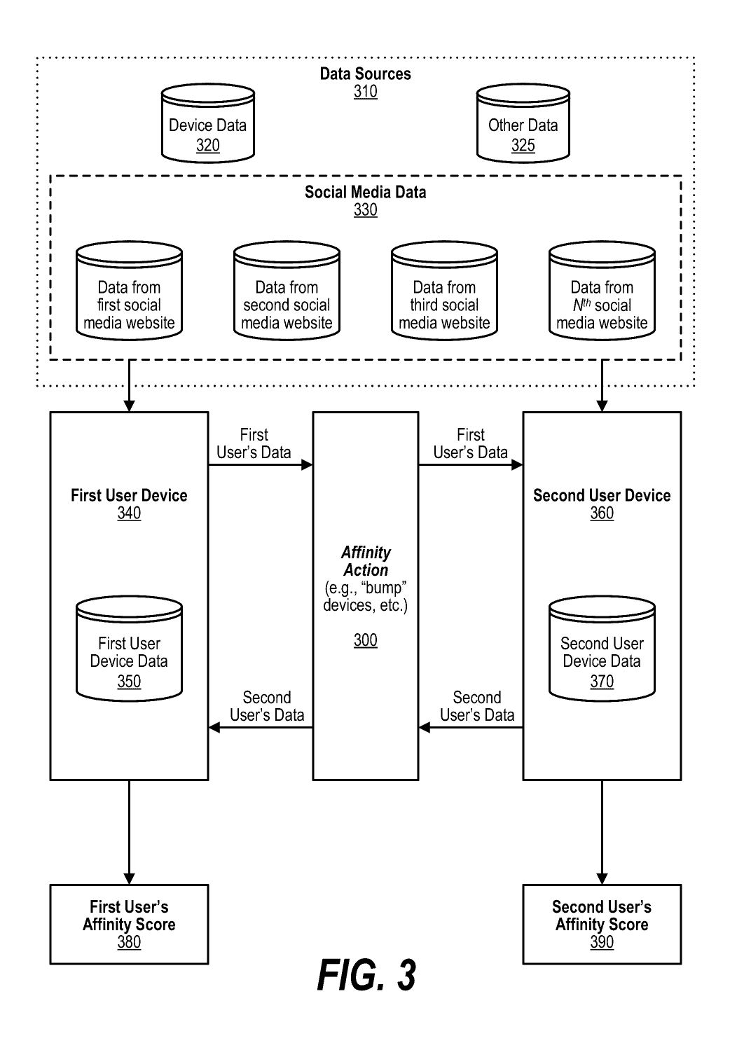

FIG. 3 is an exemplary diagram depicting the components utilized in the degrees of separation network builder. An approach is disclosed to provide a degrees of separation network builder. In the approach, action 300 is taken by a user of first mobile device 340 that communicates with second mobile device 360 that is used by a second user. For example, the action might be to “bump” the devices signifying that each of the user's wishes to perform the degrees of separation network builder process. The two devices are proximate to each other and likely held by the respective users that are engaged in a face-to-face conversation. Affinity data pertaining to the first user is accessible from first mobile device 340 and includes device data 350 pertaining to the first user as well as other data accessible from online data sources 310 that might include social media data 330 pertaining to the users as well as any other device-stored data 320, such as contacts in an online address book, and any other network-accessible data 325. Likewise, affinity data pertaining to the second user is accessible from second mobile device 360. The affinity data includes device data 370 pertaining to the second user as well as other data accessible from online data sources 310 that might include social media data 330 pertaining to the users as well as any other device-stored data 320, such as contacts in an online address book, and any other network-accessible data 325.

Affinity data of the users is shared with the affinity data of the second user being received at the first device and affinity data of the first user being received at second device 360. The degrees of separation network builder routine process the affinity data as further described herein. The degrees of separation network builder routine computes affinity score 380 based on comparing the first user's affinity data with the second user's affinity data. The affinity score reflects an estimated affinity of the first user and second user. This affinity score is displayed on one or both of the devices. In addition, affinity data, such as common interests, common contacts, etc., that was used in computing the affinity score is also available for viewing on one or both of the devices.

In one embodiment, a different affinity score can be computed by the different devices based on the weighting factors of interests configured by the respective users. In this embodiment, the degrees of separation network builder routine generates second affinity score 390 that is available for viewing on one or both of the devices and, in this embodiment, affinity score 380 might be different than affinity score 390.

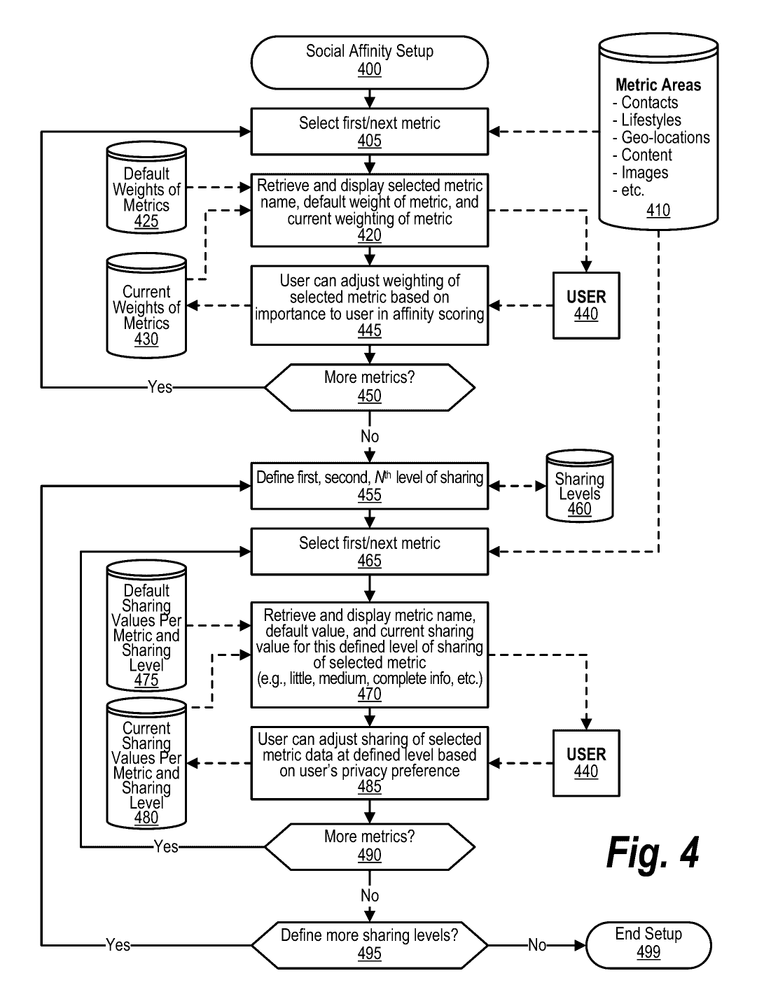

FIG. 4 is an exemplary flowchart that performs a social affinity setup process. FIG. 4 processing commences at 400 and shows the steps taken by a process that performs a setup process used by the Degrees of Separation Network Builder. At step 405, the process selects the first metric from data store 410. The metric areas include such areas as contacts, lifestyles, geo-locations, content, images, and the like. At step 420, the process retrieves and displays the selected metric name, the default weight of the selected metric retrieved from data store 425, and the current weighting of the selected metric that is retrieved from data store 430. At step 445, user 440 can adjust the weighting of the selected metric based on the importance of the metric to user in calculating the affinity score. For example, if contacts are more important than common locations, the user would provide a higher weight to contacts than to geo-locations. The process determines whether there are more metrics for the user to configure (decision 450). If there are more metrics to configure, then decision 450 branches to the ‘yes’ branch which loops back to step 405 to select and configure the next metric as described above. This looping continues until all metrics have been configured, at which point decision 450 branches to the ‘no’ branch exiting the loop.

At step 455, a loop is started that defines the number of sharing levels that the user wishes to configure. In one embodiment, general affinity data is shared at an initial sharing level (e.g., after a first “bump,” etc.) and more details are provided with successive sharing levels (e.g., after a second, third, etc. “bump”). The loop is initialized to start the first level of sharing. Step 455 retrieves the sharing levels data from data store 460. At step 465, the process selects the first metric for the first sharing level with the metric being retrieved from data store 410. At step 470, the process retrieves and displays the metric name, the default sharing value for the selected metric at the selected sharing level, and the current sharing value the selected metric at the selected sharing level (e.g., little data shared, medium amount of data shared, complete amount of data shared, etc.). Step 4709 retrieves the default sharing values per metric and sharing level are retrieved from data store 475 and the current sharing values per metric and sharing level are retrieved from data store 480.

At step 485, user 440 can adjust the sharing of data included in the selected metric at a sharing level chosen by the user with the sharing level being based on user's personal privacy preference regarding the user's affinity data, such as the user's contacts, interests, past locations, etc. The process determines as to whether there are additional metrics to configure for the current sharing level (decision 490). If there are additional metrics to configure for the current sharing level, then decision 490 branches to the ‘yes’ branch which loops back to step 465 to select and configure the next metric for this sharing level. This looping continues until there no more metrics to configure for the current sharing level, at which point decision 490 branches to the ‘no’ branch exiting the loop. The process next determines whether the user wishes to define additional sharing levels to use when sharing affinity data with another user (decision 495). If the user wishes to define additional sharing levels, then decision 495 branches to the ‘yes’ branch which loops back to step 455 to define the next sharing level as described above. This looping continues until the user does not wish to define any more sharing levels, at which point decision 495 branches to the ‘no’ branch exiting the loop. The setup process used by the Degrees of Separation Network Builder and shown in FIG. 4 thereafter ends at 499.

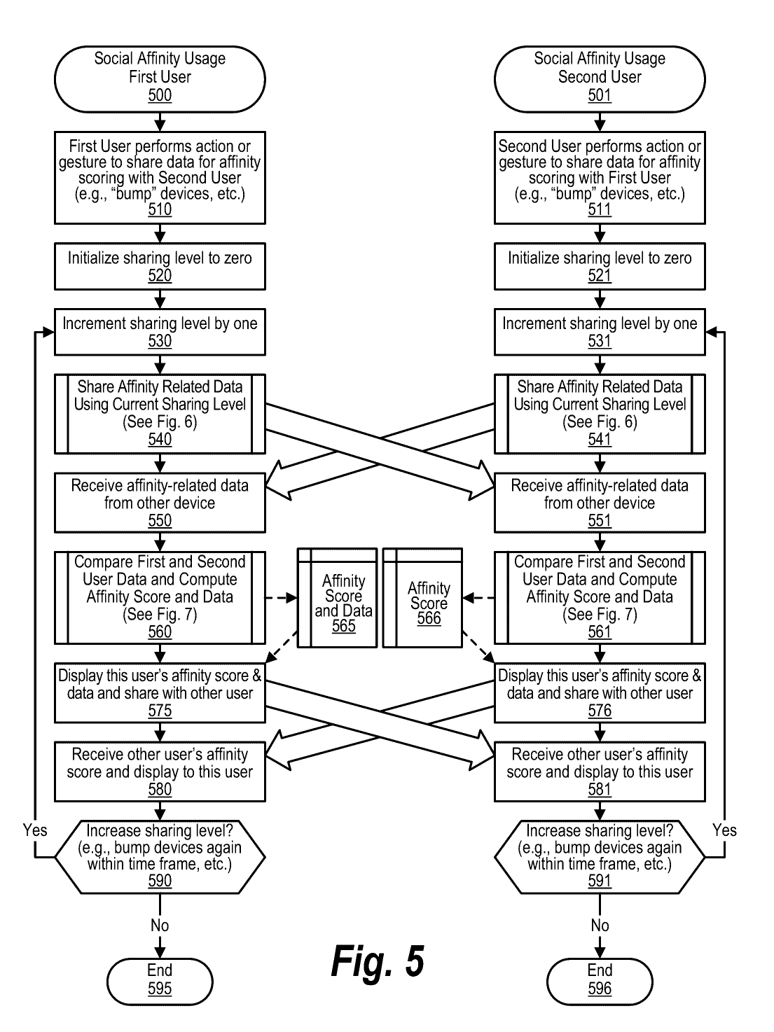

FIG. 5 is an exemplary flowchart that shows two users utilizing the social affinity process. FIG. 5 processing shows the steps taken by a process that performs a Degree of Separation Network Builder for a first user commencing at 500 and a second user commencing at 501. The steps performed for both users are essentially the same, with the steps resulting in an affinity score for both users.

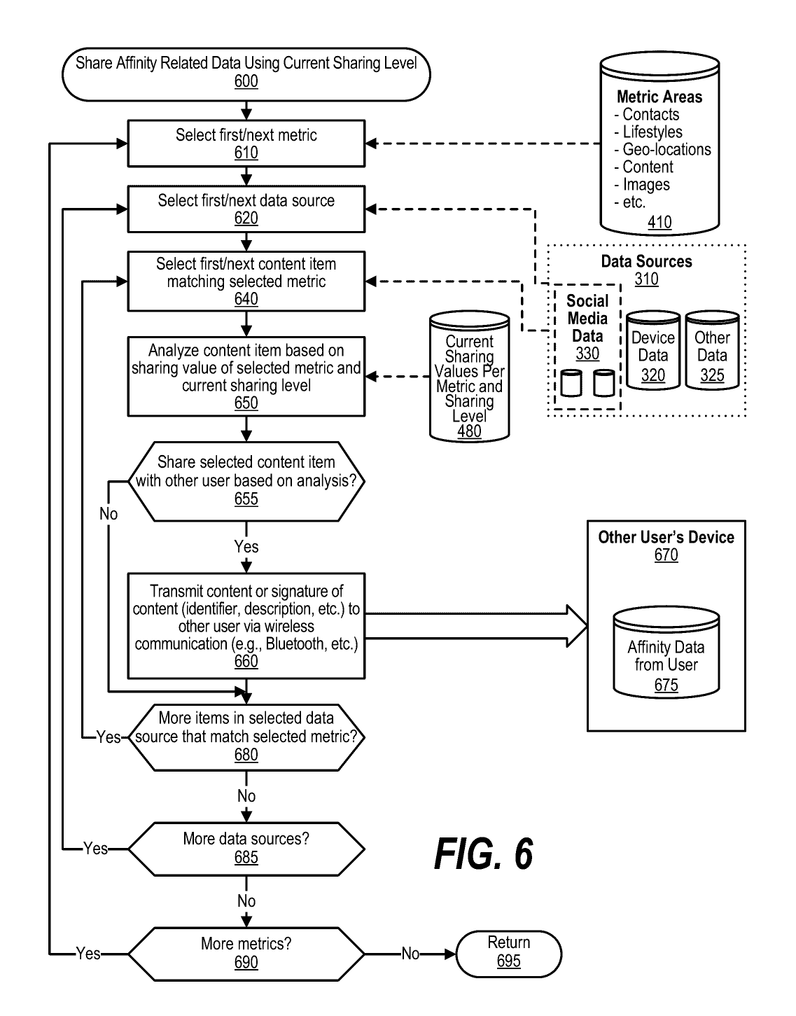

At steps 510 and 511, the first and second user processes, respectively, each perform an action or gesture indicating a desire on behalf of the respective users to share affinity data for affinity scoring with the other user (e.g., “bump” devices, etc.). At step 520 and 521, the first and second user processes, respectively, each process initializes sharing level to zero. At step 530 and 531, the first and second user processes, respectively, each increment the sharing level by one. At predefined process 540 and 541, the first and second user processes, respectively, each perform the Share Affinity Related Data Using Current Sharing Level routine (see FIG. 6 and corresponding text for processing details). At step 550 and 551, the first and second user processes, respectively, each process receives affinity-related data from other device.

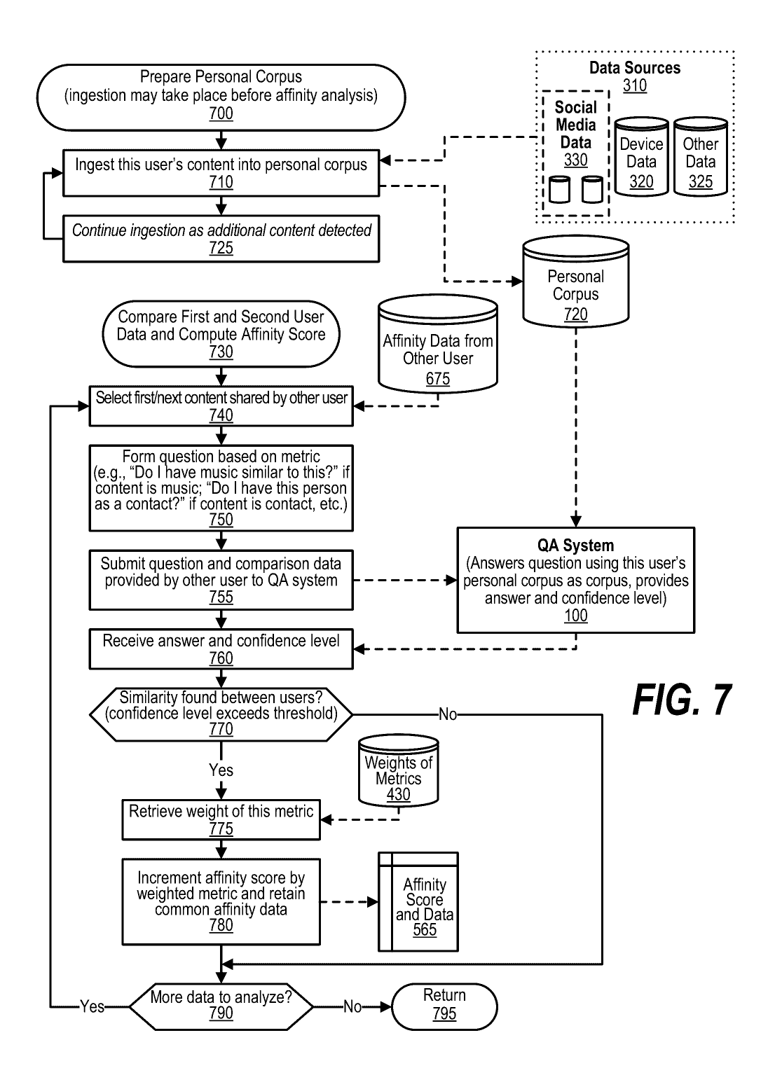

At predefined process 560 and 561, the first and second user processes, respectively, each perform the Compare First and Second User Data and Compute Affinity Score and Data routine (see FIG. 7 and corresponding text for processing details). The first user process stores the affinity score and data in memory area 565 and the second user process stores the affinity score and data in memory area 566. Memory area 565 being in a memory accessible to the first user's device, and memory area 566 being in a memory accessible to the second user's device.

At step 575 and 576, the first and second user processes, respectively, each display the respective user's affinity score the respective user's affinity data and share the affinity score and data with the other user. At step 580 and 581, the first and second user processes, respectively, each receive the other user's affinity score and data and displays such affinity scores and data to the user of the devices.

Both first and second user processes, respectively, determine whether to increase the sharing level (decision 590). For example, if another user action (e.g., “bump,” etc.) is received within a given time frame, then decisions 590/591 branches to the ‘yes’ branch which loops back to step 530/531 to increment the sharing level and repeat the process described above but using more detailed affinity data. This looping continues until no more increased sharing actions are received, at which point decision 590/591 branches to the ‘no’ branch exiting the loop. At 595 and 596, the first and second user processes, respectively, end the Degrees of Separation Network Builder process.

FIG. 6 is an exemplary flowchart that shows a process that shares affinity related data based on a current sharing level. FIG. 6 processing commences at 600 and shows the steps taken by a process that shares affinity related data based on the current sharing level. At step 610, the process selects the first metric from data store 410 (e.g., contacts, lifestyles, geo-locations, content, images, interests, hobbies, etc.). At step 620, the process selects the first data source from data sources 310. At step 640, the process selects the first content item (e.g., contact data, interest data, geo-location data, image, etc.) that matches selected metric.

At step 650, the process analyzes the selected content item based on the current sharing value of the selected metric and the current sharing level. For example, images of the user that are publicly accessible from social media sites might be shared at a low sharing level (e.g., level one, etc.), while images of the user that are private and stored on the user's mobile device might only be shared at a higher sharing level (e.g., level two or three, etc.). Likewise, contacts of the user visible from social media sites might be shared at a low level (one “bump”), business contacts of the user stored on the user's address book or smart phone might be shared at an intermediate sharing level (two “bumps”), and private family contacts of the user's children and other relatives might only be shared at a high sharing level (three “bumps”).

Based on the analysis performed at step 650, the process determines whether to share the selected content item with the other user (decision 655). If the content is to be shared, then decision 655 branches to the ‘yes’ branch to perform transmit step 660. On the other hand, if the item is not being shared at this time, then decision 655 branches to the ‘no’ branch bypassing step 660. At step 660, the process transmits the content (e.g., image, contact data, etc.) or a signature of the content (identifier, description, etc.) to the other user via wireless communication (e.g., Bluetooth, etc.).

The process next determines whether there are more items from the selected data source that match the selected metric (decision 680), such as more images, contacts, etc. If there are more items from the selected data source that match the selected metric, then decision 680 branches to the ‘yes’ branch which loops back to step 640 to select the next content item and process it as described above. This looping continues until there are no more items from the selected data source that match the selected metric, at which point decision 680 branches to the ‘no’ branch exiting the loop.

Next, the process determines whether there are more data sources to process (decision 685). If there are more data sources to process, then decision 685 branches to the ‘yes’ branch which loops back to step 620 to select and process data from the next data source as described above. This looping continues until there are no more data sources to process, at which point decision 685 branches to the ‘no’ branch exiting the loop. Finally, the process determines whether there are more metrics to process (decision 690). If there are more metrics to process, then decision 690 branches to the ‘yes’ branch which loops back to step 610 to select and process the next metric as described above. This looping continues until there are no more metrics to process, at which point decision 690 branches to the ‘no’ branch exiting the loop. FIG. 6 processing thereafter returns to the calling routine (see FIG. 5) at 695.

FIG. 7 is an exemplary flowchart that shows a process compares shared affinity data and computes an affinity score. FIG. 7 shows two processes being performed. The first process commences at 700 and shows the steps taken to prepare the user's Personal Corpus to a form that is accessible by QA system 100. Ingestion of the user's personal corpus may be ongoing and may take place before the affinity analysis process. At step 710, the process ingests this user's content data personal corpus 720. The user's content data is ingested from the user's mobile device as well as from data stores accessible to the user, such as social media sites. At step 725, the process continues ingesting the user's personal content as additional personal content is detected. When more personal content is detected, processing loops back to step 710 to ingest such content into personal corpus 720.

The process that compares the first user's data with the second user's data and computes an affinity score is shown commencing at 730. At step 740, the process selects the first content item (e.g., contact data, image data, interest data, geo-location data, etc.) that was shared by the other user. At step 750, the process forms a natural language question based on the metric that corresponds to the selected content item. For example, if the content item is a description of digital music, the question might be “Do I have music similar to this?” If the content is contact data, the question might be “Do I have this person as a contact?” At step 755, the process submits the question formed at step 750 and the comparison data provided by other user to QA system 100. At step 760, the process receives an answer from QA system 100 along with a confidence level, or score, as to the QA system's confidence of the answer.

The process determines as to whether a similarity was found between the two users based on the comparison performed by the QA system (decision 770). In one embodiment, a positive similarity found by the QA system also needs a confidence score on the finding that meets or exceeds a particular threshold. If a similarity was found between the two users, then decision 770 branches to the ‘yes’ branch to perform steps 775 and 780. On the other hand, if a similarity was not found between the two users, then decision 770 branches to the ‘no’ branch bypassing steps 775 and 780. At step 775, the process retrieves the weight of this metric as configured by this user. The weights of the various metrics are retrieved from data store 430. At step 780, the process increments the affinity score by the weighted metric and the process further retains the affinity data that was found to be in common between the two users. The affinity score and common data are stored in memory area 565.

The process determines whether there are more data items shared by the other user that need to be analyzed (decision 790). If there are more data items shared by the other user that need to be analyzed, then decision 790 branches to the ‘yes’ branch which loops back to step 740 to select and analyze the next data item as described above. This looping continues until there are no more data items shared by the other user that need to be analyzed, at which point decision 790 branches to the ‘no’ branch exiting the loop. FIG. 7 processing thereafter returns to the calling routine (see FIG. 5) at 795.

While particular embodiments of the present disclosure have been shown and described, it will be obvious to those skilled in the art that, based upon the teachings herein, that changes and modifications may be made without departing from this disclosure and its broader aspects. Therefore, the appended claims are to encompass within their scope all such changes and modifications as are within the true spirit and scope of this disclosure. Furthermore, it is to be understood that the disclosure is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to disclosures containing only one such element, even when the same claim includes the introductory phrases “one or more” or “at least one” and indefinite articles such as “a” or “an”; the same holds true for the use in the claims of definite articles.

1. A method implemented by an information handling system that includes a memory and a processor, the method comprising:
responsive to an action taken by a first user of a first mobile device, communicating with a second mobile device that corresponds to a second user, wherein the first and second mobile devices are proximate to each other, and wherein a first set of affinity data pertaining to the first user is accessible from the first mobile device;
receiving, at the first mobile device, a second set of affinity data from the second mobile device, wherein the second set of affinity data pertains to the second user;
computing a first affinity score based on comparing the first set of affinity data with the second set of affinity data, wherein the first affinity score reflects an estimated affinity of the first user to the second user; and
displaying the computed first affinity score to the first user.

2. The method of claim 1 further comprising:
transmitting the first set of affinity data from the first mobile device to the second mobile device;
computing a second affinity score based on comparing the second set of affinity data with the first set of affinity data, wherein the second affinity score reflects an estimated affinity of the second user to the first user; and
displaying the computed second affinity score at one or more of the mobile devices.

3. The method of claim 1 wherein a plurality of levels of affinity data are received, the method further comprising:
receiving a first level of affinity data from the second mobile device in response to a first action taken by the first user, wherein the first level of affinity data is used as the second set of affinity data in computing the first affinity score; and
receiving a second level of affinity data from the second mobile device in response to a second action taken by the first user after the first action, wherein the second level of affinity data is used as the second set of affinity data in computing a second affinity score that is displayed to the first user, and wherein the second level of affinity data includes greater detail than the first level of affinity data.

4. The method of claim 3 further comprising:
prior to taking the action by the first user, configuring the plurality of levels of affinity data, wherein the configuring of the levels of affinity data defines an extent of data shared at each of the configured levels of affinity data.

5. The method of claim 4 further comprising:
identifying a current level of sharing based upon the action taken by the first user;
analyzing a plurality of affinity data items corresponding to the first user, wherein the analyzing identifies one or more affinity data items to include in the first set of affinity data based on the current level of sharing, the type of data of the data items, the configured extent of data shared at the current level of sharing; and
transmitting the first set of affinity data from the first mobile device to the second mobile device.

6. The method of claim 1 further comprising:
prior to taking the action by the first user, configuring a plurality of metrics, wherein each of the metrics corresponds to a type of affinity data, and wherein the configuring includes adjusting a weight value used for the plurality of metrics; and
wherein the computing utilizes the weight value associated with the plurality of metrics when computing the first affinity score.

7. The method of claim 1 wherein the computing of the first affinity score further comprises:
ingesting the first set of affinity data into a corpus utilized by a question answering (QA) system;
forming an affinity-based natural language question pertaining to one of the data items included in the second set of affinity data received from the second mobile device;
submitting the formed affinity-based natural language question to the QA system;
receiving an affinity-based answer from the QA system; and
adjusting the affinity score based on the affinity-based answer.

8. An information handling system comprising:
one or more processors;
one or more data stores accessible by at least one of the processors;
a memory coupled to at least one of the processors; and
a set of computer program instructions stored in the memory and executed by at least one of the processors in order to perform actions of:
responsive to an action taken by a first user of a first mobile device, communicating with a second mobile device that corresponds to a second user, wherein the first and second mobile devices are proximate to each other, and wherein a first set of affinity data pertaining to the first user is accessible from the first mobile device;
receiving, at the first mobile device, a second set of affinity data from the second mobile device, wherein the second set of affinity data pertains to the second user;
computing a first affinity score based on comparing the first set of affinity data with the second set of affinity data, wherein the first affinity score reflects an estimated affinity of the first user to the second user; and
displaying the computed first affinity score to the first user.

9. The information handling system of claim 8 wherein the actions further comprise:
transmitting the first set of affinity data from the first mobile device to the second mobile device;
computing a second affinity score based on comparing the second set of affinity data with the first set of affinity data, wherein the second affinity score reflects an estimated affinity of the second user to the first user; and
displaying the computed second affinity score at one or more of the mobile devices.

10. The information handling system of claim 8 wherein a plurality of levels of affinity data are received, wherein the actions further comprise:
receiving a first level of affinity data from the second mobile device in response to a first action taken by the first user, wherein the first level of affinity data is used as the second set of affinity data in computing the first affinity score; and
receiving a second level of affinity data from the second mobile device in response to a second action taken by the first user after the first action, wherein the second level of affinity data is used as the second set of affinity data in computing a second affinity score that is displayed to the first user, and wherein the second level of affinity data includes greater detail than the first level of affinity data.

11. The information handling system of claim 10 wherein the actions further comprise:
prior to taking the action by the first user, configuring the plurality of levels of affinity data, wherein the configuring of the levels of affinity data defines an extent of data shared at each of the configured levels of affinity data.

12. The information handling system of claim 11 wherein the actions further comprise:
identifying a current level of sharing based upon the action taken by the first user;
analyzing a plurality of affinity data items corresponding to the first user, wherein the analyzing identifies one or more affinity data items to include in the first set of affinity data based on the current level of sharing, the type of data of the data items, the configured extent of data shared at the current level of sharing; and
transmitting the first set of affinity data from the first mobile device to the second mobile device.

13. The information handling system of claim 8 wherein the actions further comprise:
prior to taking the action by the first user, configuring a plurality of metrics, wherein each of the metrics corresponds to a type of affinity data, and
wherein the configuring includes adjusting a weight value used for the plurality of metrics; and
wherein the computing utilizes the weight value associated with the plurality of metrics when computing the first affinity score.

14. The information handling system of claim 8 wherein the computing of the first affinity score further comprises:
ingesting the first set of affinity data into a corpus utilized by a question answering (QA) system;
forming an affinity-based natural language question pertaining to one of the data items included in the second set of affinity data received from the second mobile device;
submitting the formed affinity-based natural language question to the QA system;
receiving an affinity-based answer from the QA system; and
adjusting the affinity score based on the affinity-based answer.

15. A computer program product stored in a computer readable storage medium, comprising computer program code that, when executed by an information handling system, causes the information handling system to perform actions comprising:
responsive to an action taken by a first user of a first mobile device, communicating with a second mobile device that corresponds to a second user, wherein the first and second mobile devices are proximate to each other, and wherein a first set of affinity data pertaining to the first user is accessible from the first mobile device;
receiving, at the first mobile device, a second set of affinity data from the second mobile device, wherein the second set of affinity data pertains to the second user;
computing a first affinity score based on comparing the first set of affinity data with the second set of affinity data, wherein the first affinity score reflects an estimated affinity of the first user to the second user; and
displaying the computed first affinity score to the first user.

16. The computer program product of claim 15 wherein the actions further comprise:
transmitting the first set of affinity data from the first mobile device to the second mobile device;
computing a second affinity score based on comparing the second set of affinity data with the first set of affinity data, wherein the second affinity score reflects an estimated affinity of the second user to the first user; and
displaying the computed second affinity score at one or more of the mobile devices.

17. The computer program product of claim 15 wherein a plurality of levels of affinity data are received, wherein the actions further comprise:
receiving a first level of affinity data from the second mobile device in response to a first action taken by the first user, wherein the first level of affinity data is used as the second set of affinity data in computing the first affinity score; and
receiving a second level of affinity data from the second mobile device in response to a second action taken by the first user after the first action, wherein the second level of affinity data is used as the second set of affinity data in computing a second affinity score that is displayed to the first user, and wherein the second level of affinity data includes greater detail than the first level of affinity data.

18. The computer program product of claim 17 wherein the actions further comprise:
prior to taking the action by the first user, configuring the plurality of levels of affinity data, wherein the configuring of the levels of affinity data defines an extent of data shared at each of the configured levels of affinity data;
after receiving the action by the first user:
identifying a current level of sharing based upon the action taken by the first user;
analyzing a plurality of affinity data items corresponding to the first user, wherein the analyzing identifies one or more affinity data items to include in the first set of affinity data based on the current level of sharing, the type of data of the data items, the configured extent of data shared at the current level of sharing; and
transmitting the first set of affinity data from the first mobile device to the second mobile device.

19. The computer program product of claim 15 wherein the actions further comprise:
prior to taking the action by the first user, configuring a plurality of metrics, wherein each of the metrics corresponds to a type of affinity data, and wherein the configuring includes adjusting a weight value used for the plurality of metrics; and
wherein the computing utilizes the weight value associated with the plurality of metrics when computing the first affinity score.

20. The computer program product of claim 15 wherein the computing of the first affinity score further comprises:
ingesting the first set of affinity data into a corpus utilized by a question answering (QA) system;
forming an affinity-based natural language question pertaining to one of the data items included in the second set of affinity data received from the second mobile device;
submitting the formed affinity-based natural language question to the QA system;
receiving an affinity-based answer from the QA system; and
adjusting the affinity score based on the affinity-based answer.
